(19) United States
(12) Patent Application Publication
(10) Pub. No.: US 2007/0030699 A1
(43) Pub. Date: Feb. 8, 2007

(54) BACKLIGHT MODULE STRUCTURE

(75) Inventors: Te-Hai Tseng, TAOYUAN (TW); Kuang-Tao Sung, Taichung (TW); Hung-Chih Chen, Taicheng (TW)

Correspondence Address: SQUIRE, SANDERS & DEMPSEY L.L.P, PATENT DEPARTMENT, ONE MARITIME PLAZA, SUITE 300, SAN FRANCISCO, CA, 94111-3492, US

(73) Assignee: AU OPTRONICS CORPORATION, Hsinchu (TW)

(21) Appl. No.: 11/163,513

(22) Filed: Oct. 21, 2005

(30) Foreign Application Priority Data
Aug. 8, 2005 (TW) 94126717

(51) Int. Cl. F21V 7/04

(52) U.S. Cl. 362/633; 362/632; 362/624

(57) ABSTRACT

The present invention provides a backlight module structure. The backlight module structure comprises a frame integral with a light guide plate, a shielding tape and a reflector. An extended portion of the shielding tape or an extended portion of the reflector is used to cover a feed point of a light guide molding material. This structure of the backlight module prevents production of a dark area, and makes the light to be utilized more effectively.

### CROSS REFERENCE TO RELATED APPLICATION

This application claims the benefit of Taiwan application Serial No. 094126717, filed Aug. 8, 2005.

### FIELD OF THE INVENTION

The present invention relates to a backlight module structure, and more particularly, to a backlight module structure having a light guide plate for preventing light leakage.

### DESCRIPTION OF THE RELATED ART

As photoelectric industry develops rapidly, liquid crystal display (LCD) module has been commonly applied in electronic devices, such as notebook computers, personal digital assistants (PDAs), mobile phones, etc. Since liquid crystal display panel does not emit light by itself, an external light source is required. A backlight module is employed in liquid crystal display as the light source, for providing sufficient brightness and uniform distribution to perform properly display images.

Referring to FIG. 1A, there is shown an explosive view of a conventional liquid crystal display 100. As shown in FIG. 1A, the liquid crystal display 100 includes an outer frame 102, a liquid crystal display panel 108, a driver 109, and a backlight module 120. Referring to FIG. 1B, there is shown a cross-sectional schematic view of the conventional liquid crystal display 100. As shown in FIG. 1B, the backlight module 120 comprises a frame 104, a plurality of optical films 110, a light source 112, a light guide plate 114, a shielding tape 106, a reflector 116, and a lamp holder 118. The frame 104 includes a frame body 104a and a holding chamber 105. The reflector 116, the light guide plate 114, the light source 112, and the optical films 110 are integrated into the backlight module 120 and located in the holding chamber 105. Furthermore, the reflector 116, the light guide plate 114, and the optical films 110 are stacked in this order from bottom to top in the holding chamber 105. A gap, formed between the light guide plate 114 and the frame 104 or between the light guide plate 114 and the optical films 110, around the light guide plate 114 is covered by the shielding tape 106 to prevent light leakage. The light source 112 is disposed in the lamp holder 118 and located to one side of the holding chamber 105 of the frame 104. In addition, the liquid crystal display panel 108 is mounted on the backlight module 120 and fixed by the outer frame 102.

The light guide plate 114 comprises a protrusion, thereby assembling the frame 104 with the light guide plate 114 together in the backlight module 120. However, production cost of backlight module of liquid crystal display has been always high, less expensive than color filter. In order to reduce the production cost of the backlight module, the light guide plate integral with the frame is manufactured by double injection molding. FIG. 2A shows a vertical view of a double injection molding module, a frame molding material and a light guide molding material are injected into a mold cavity 130 via a frame molding material feed point 132 and a light guide molding material feed point 134 individually by a double injection apparatus (not shown). After the frame molding material and the light guide molding material are solidified and jointed together, a structure that a frame integral with a light guide plate is obtained while the double injection molding module is opened.

However, referring to FIG. 2B, a light guide molding material feed point 134 is needed while a frame 104 integral with a light guide plate 114 is manufactured by double injection molding. The light guide molding material feed point 134 is not allowed to be covered by the frame 104, therefore, the light guide molding material feed point 134, i.e. a gap, is formed in the frame 104. As a result, while a light is emitted through the light guide molding material feed point 134, some of the light is lost from the gap 134 where there is no frame to prevent the light leakage, thereby causing the light to work inefficiently and distribute unevenly. In the meantime, a dark area is also produced while the liquid crystal display is operated. The dark area will cause the liquid crystal display to reveal an uneven brightness distribution and an inferior image quality.

Accordingly, it is required to prevent light leakage from a structure that a frame integral with a light guide plate manufactured by the double injection molding to improve light efficiency, brightness, and uniformity.

### SUMMARY OF THE INVENTION

The present invention provides a backlight module structure for preventing a light leakage from a structure that a frame integral with a light guide plate manufactured by double injection molding, wherein a feed point is formed in the frame, causing light leakage. The present invention can also prevent production of a dark area of a liquid crystal display caused by a light leakage, wherein the dark area will cause the light to work inefficiently and distribute unevenly. Therefore, a liquid crystal display with a high light efficiency, brightness, and uniformity is obtained.

The present invention further provides an improved backlight module structure for preventing light leakage from a feed point of a structure that a frame integral with a light guide plate manufactured by double injection molding. The backlight module structure comprises: a frame having a hollow and a plurality of protrusions, wherein the plurality of protrusions are located on an outer lateral side of the frame; a light guide plate mounted on the frame; and a shielding tape located around edge of the frame. The backlight module typically further comprises a reflector located under the light guide plate, and a plurality of optical films arranged above the light guide plate.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1A and FIG. 1B are schematic representations of a conventional liquid crystal display individually;

FIG. 2A and FIG. 2B are schematic representations of a structure that a frame integral with a light guide plate manufactured by double injection molding individually;

FIG. 3A to 3E are schematic representations of structures according to one embodiment of the present invention;

FIG. 4A to 4C are schematic representations of structures according to another embodiment of the present invention; and

FIG. 5A to 5C are schematic representations of structures according to still another embodiment of the present invention.

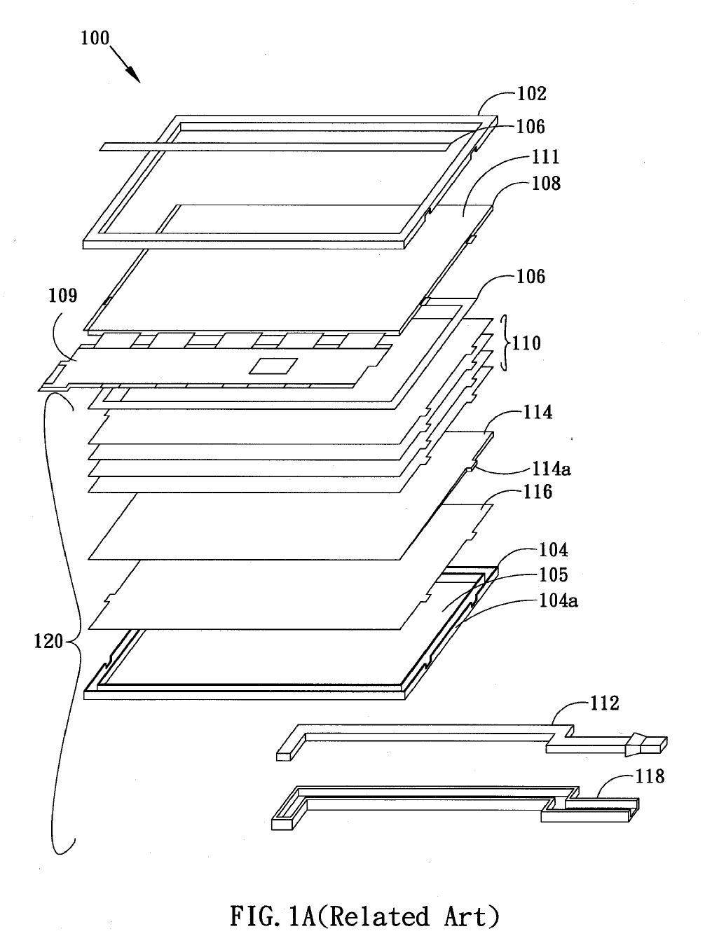

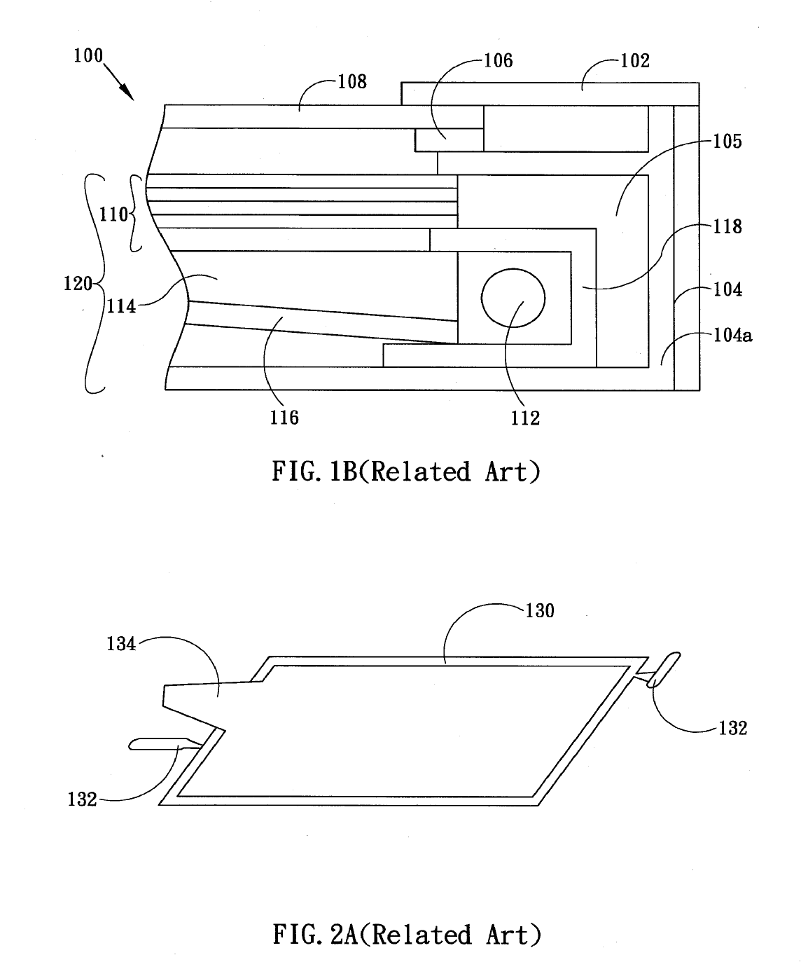

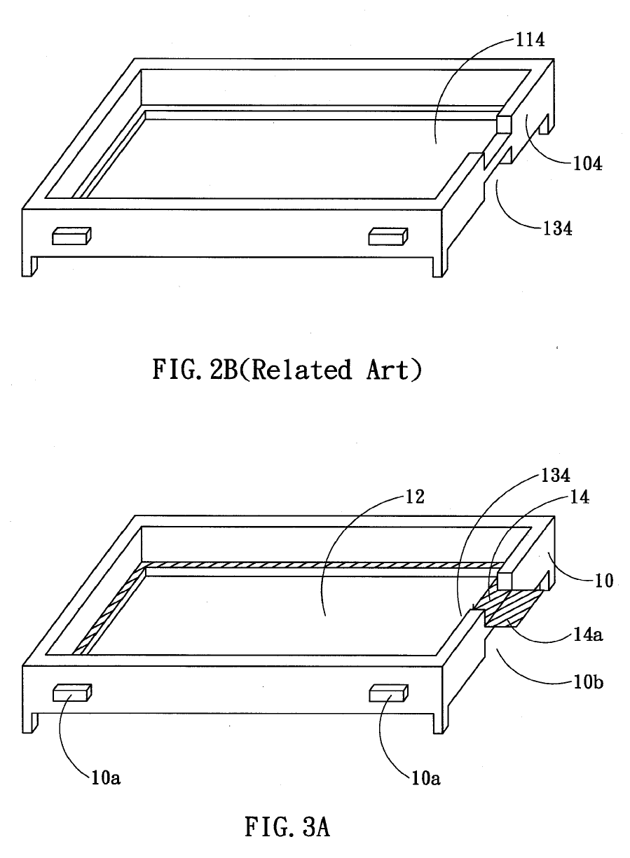

### DESCRIPTION OF THE PREFERRED EMBODIMENT

Some sample embodiments of the invention will now be described in greater detail. Nevertheless, it should be recognized that the present invention can be practiced in a wide range of other embodiments besides those explicitly described, and the scope of the present invention is expressly not limited except as specified in the accompanying claims.

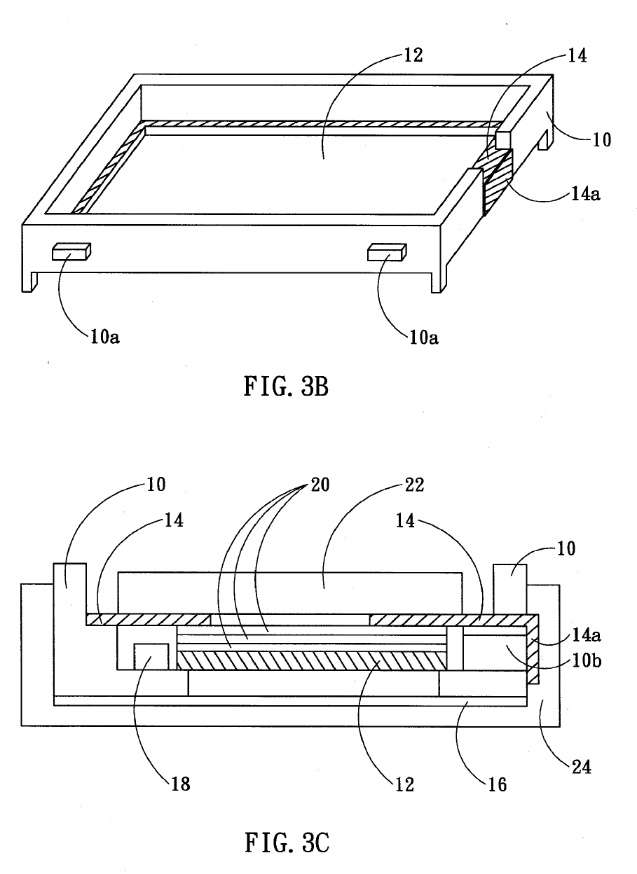

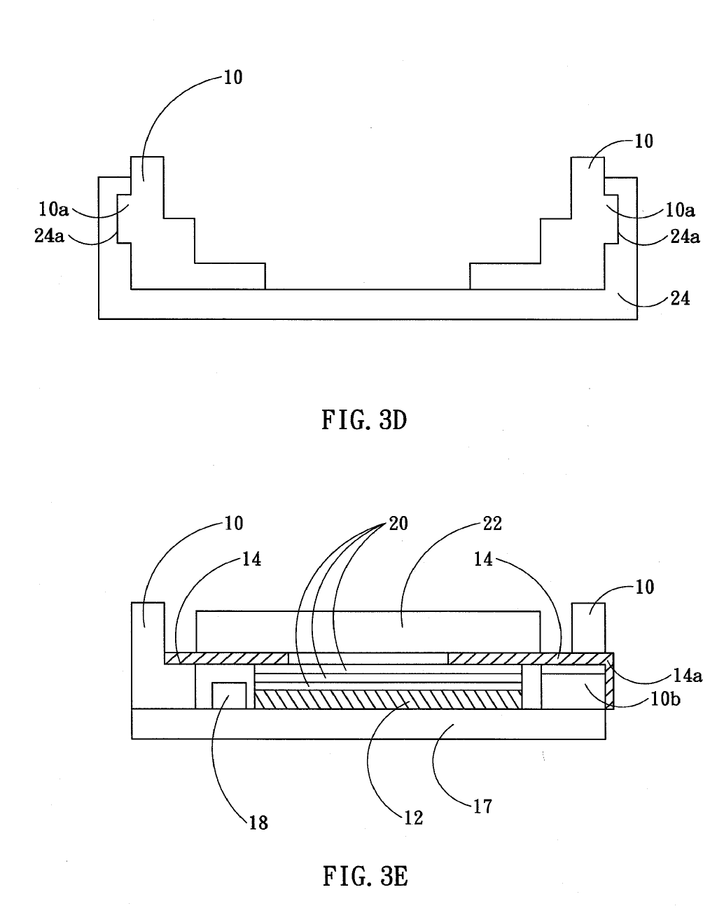

Referring to FIG. 3A, there is shown a three-dimensional schematic view of a backlight module according to one embodiment of the present invention. The backlight module includes: a frame 10 having a plurality of protrusions 10a, wherein the plurality of protrusions 10a are located on an outer lateral side of the frame 10; a cavity 10b formed in a side wall of the frame 10; a light guide plate 12 mounted on the frame 10; and a shielding tape 14 having an extended portion 14a located corresponding to the cavity 10b. As shown in FIG. 3B, the extended portion 14a is bent down at substantially a angle to cover the cavity 10b to prevent light leakage therefrom. Therefore, a dark area caused by the light leakage is avoided.

Furthermore, the frame 10 and the light guide plate 12 are formed simultaneously or as a whole by double injection molding, and the cavity 10b is a light guide molding material feed point that is not covered by the frame in conventional techniques.

Referring to FIG. 3C, there is shown a cross-sectional schematic view of a liquid crystal display assembled with the above-mentioned backlight module. The liquid crystal display includes the frame 10 that is integrated with the light guide plate 12. One or a plurality of light sources 18, such as light emitting diodes (LEDs) or cold cathode fluorescence lamp (CCFL), can be disposed inside the frame 10. The light sources 18, whose positions are not limited, are used to provide the illumination for the liquid crystal display. The cavity 10b is formed in one side wall of the frame 10. Moreover, the multiple optical films 20 and the shielding tape 14 used to cover the edge of the frame 10 are located above the light guide plate 12. In addition, the shielding tape 14 has the extended portion 14a that is bent down to cover the cavity 10b. A liquid crystal display panel 22 is located above the shielding tape 14.

As shown in FIG. 3C, according to the description of this embodiment, the frame 10 has a hollow. Furthermore, a bezel 24 located under a reflector 16 is used to provide accommodation, fixity, and the protection of the reflector 16 and the frame 10. The frame 10 can be assembled with the bezel 24 according to the example of FIG. 3D. As shown in FIG. 3D, a plurality of grooves 24a are formed in a side wall of the bezel 24. The plurality of grooves 24a of the bezel 24 are located corresponding to the positions of a plurality of protrusions 10a that is located on an outer lateral side of the frame 10. The frame 10 is fixed to the bezel 24 by combining the plurality of protrusions 10a with the corresponding plurality of grooves 24a.

However, the frame 10 of the embodiment according to the present invention is not limited to a hollow structure. FIG. 3E shows a cross-sectional schematic view of a liquid crystal display with a backlight module according to another embodiment of the present invention. The liquid crystal display structure shown in FIG. 3E is substantially the same as that shown in FIG. 3C, except that the frame 10 is an entire piece of structure, and a bottom 17 of the frame 10 is reflective and takes the place of the reflector 16 (as shown in FIG. 3C) to reflect the light. Since the bottom 17 of the frame 10 can be served as a reflector sheet/plate, the bezel 24 is not necessarily required to accommodate and fix the frame 10 and the reflector 16. Nevertheless, a bezel 24 can further protect a backlight module as described in the other embodiments of the present invention.

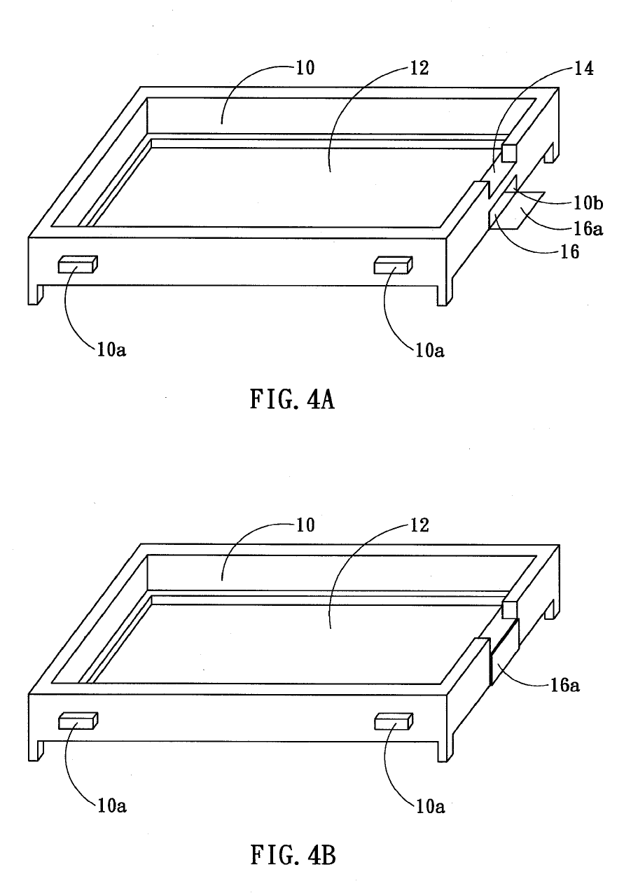

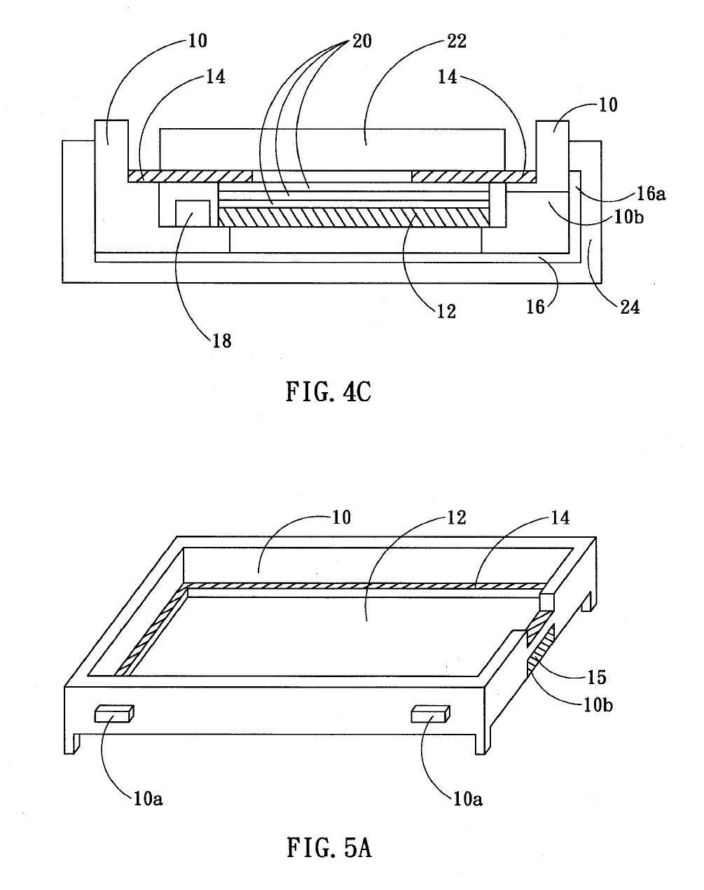

Referring to FIG. 4A, there is shown a three-dimensional schematic view of a backlight module according to a preferred embodiment of the present invention. The backlight module includes: a frame 10 having a plurality of protrusions 10a located on an outer lateral side of the frame 10 and a cavity 10b formed in a side wall of the frame 10; a light guide plate 12 mounting on the frame 10; a shielding tape 14 located around edge of the frame 10 to prevent the light leakage from the cavity 10b of the backlight module; and a reflector tape 16 having an extended portion 16a, wherein the reflector tape 16 is located under the frame 10. The extended portion 16a, as shown in FIG. 4B, is bent up at substantially a angle to cover a light guide plate molding material feed point 10b (i.e. the cavity) to prevent the light leakage therefrom. Therefore, a dark area caused by the light leakage is avoided. Certainly, the frame 10 is integrated with the light guide plate 12 by double injection molding in this embodiment.

Referring to FIG. 4C, there is shown a cross-sectional schematic view of a liquid crystal display assembled with the above-mentioned backlight module. The liquid crystal display includes a structure that a frame 10 is integrated with a light guide plate 12. One or more light sources 18, such as light emitting diodes (LEDs) or cold cathode fluorescence lamp (CCFL), can be disposed inside the frame 10 to provide illumination for the liquid crystal display. The cavity 10b is formed in one side wall of the frame 10. Moremore, a plurality of optical films 20 and the shielding tape 14 used to cover the edge of the frame 10 are located above the light guide plate 12, and the reflector 16 having the extended portion 16a is located under the frame 10, wherein the extended portion 16a is bent up to cover the cavity 10b. A liquid crystal display panel 22 is located above the shielding tape 14. According to the description of this embodiment, the frame 10 has a hollow. Furthermore, a bezel 24 located under the reflector 16 is used to provide accommodation, fixity, and the protection of the reflector 16 and the frame 10. The frame 10 can be assembled with the bezel 24 according to the description of the above-mentioned embodiment, the grooves 24a of the bezel 24 are combined with the corresponding plurality of protrusions 10a located on the outer lateral side of the frame 10, as shown in FIG. 3D. Therefore, the frame 10 is fixed to the bezel 24.

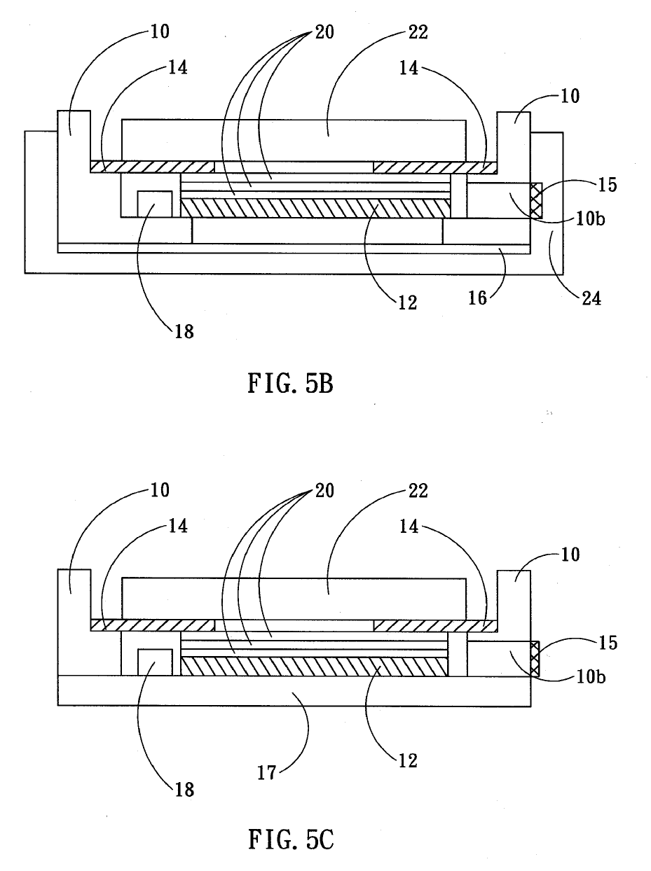

Referring to FIG. 5A, there is shown a three-dimensional schematic view of a backlight module according to still another embodiment of the present invention. The backlight module comprises: a frame 10 having a plurality of protrusions 10a, wherein the plurality of protrusions 10a are located on an outer lateral side of the frame 10; and a light guide plate 12 mounted on the frame 10. Similarly, the frame 10 is integrated with the light guide plate 12 by double injection molding, and a light guide molding material feed point, a cavity 10b, is formed in a side wall of the frame 10. A first shielding tape 14 is located around edge of the frame 10, and a second shielding tape 15 which is capable of sticking to the cavity 10b directly is used to cover the cavity 10b to prevent light leakage. Therefore, a dark area caused by the light leakage is avoided. The second shielding tape 15 may comprise an opaque tape, an opaque film such as a reflector sheet or a stainless steel board, and any other suitable material for a particular design.

In addition, the frame 10 of this embodiment can also have a hollow structure, as shown in FIG. 5B. The second shielding tape 15 is capable of sticking to the cavity 10b of the frame 10 directly. A bezel 24 is further provided to accommodate or fix the frame 10 and the reflector 16. The bezel 24 is assembled with the frame 10 by combining the plurality of protrusions 10a of the frame 10 with the corresponding plurality of grooves 24a of the bezel 24, as shown in FIG. 3D. The second shielding tape 15 can also be a part of the bezel 24 in other embodiments, i.e. the height of the side wall of the bezel 24 can be increased to cover the cavity 10b. Otherwise, as shown in FIG. 5C, the frame 10 can be an entire piece of structure, the second shielding tape 15 is capable of sticking to the cavity 10b of the frame 10 directly, and a bottom 17 of the frame 10 can be served as a reflector sheet. The second shielding tape 15 may comprise an opaque tape, an opaque film such as a reflector sheet or a stainless steel board, and any other suitable material for a particular design.

The present invention prevents light leakage from a backlight module by using an extended portion of a shielding tape or an extended portion of a reflector, or a shielding tape sticking directly to a light guide molding material feed point of the backlight module whose frame is integral with light guide plate. The present invention also prevents a dark area produced by light leakage from the light guide molding material feed point, making the back light source to be utilized more effectively, and the brightness to be more uniform.

Although specific embodiments have been illustrated and described, it will be obvious to those skilled in the art that various modifications may be made without departing from what is intended to be limited solely by the appended claims.

What is claimed is:

1. A backlight module structure, comprising:
a frame having a plurality of protrusions located on at least one lateral side of said frame and a cavity formed in a side wall of said frame;
a light guide plate mounted on said frame; and
a shielding tape, located around the edge of said frame, having an extended portion adapted to cover said cavity.

2. The backlight module structure according to claim 1, wherein said frame and said light guide plate are formed as a whole by a double injection molding.

3. The backlight module structure according to claim 1, wherein said extended portion of said shielding tape is bent to cover said cavity.

4. The backlight module structure according to claim 1, further comprising a reflector located under said frame.

5. The backlight module structure according to claim 4, wherein said reflector has an extending portion adapted to cover said cavity.

6. The backlight module structure according to claim 1, wherein said frame is an entire piece of structure.

7. The backlight module structure according to claim 4, further comprising a bezel located under said reflector, wherein said bezel has a plurality of grooves formed in a side wall of said bezel, and said reflector and said frame are fixed to said bezel by combining said plurality of grooves with said plurality of protrusions correspondingly.

8. The backlight module structure according to claim 1, wherein said shielding tape is located between said frame and said light guide plate.

9. The backlight module structure according to claim 1, wherein said frame has a hollow formed therein.

10. A backlight module structure, comprising:
a frame having a plurality of protrusions located on at least one lateral side of said frame and a cavity formed in a side wall of said frame;
a light guide plate mounted on said frame;
a shielding tape located around the edge of said frame; and
a reflector located under said frame, wherein said reflector has an extending portion adapted to cover said cavity.

11. The backlight module structure according to claim 10, wherein said frame and said light guide plate are formed as a whole by a double injection molding.

12. The backlight module structure according to claim 10, wherein said extending portion of said reflector is bent to cover said cavity.

13. The backlight module structure according to claim 10, further comprising a bezel located under said reflector, wherein said bezel has a plurality of grooves formed in a side wall of said bezel, and said reflector and said frame are fixed to said bezel by combining said plurality of grooves with said plurality of protrusions correspondingly.

14. The backlight module structure according to claim 10, wherein said shielding tape is located between said frame and said light guide plate.

15. The backlight module structure according to claim 10, wherein said frame has a hollow formed therein.

16. A backlight module structure, comprising:
a frame having a plurality of protrusions located on at least one lateral side of said frame and a cavity formed in a side wall of said frame;
a light guide plate mounted on said frame;
a first shielding tape located around edge of said frame;
a second shielding tape located on said cavity, wherein said second shielding tape has a shape corresponding to that of said cavity; and
a reflector located under said frame.

17. The backlight module structure according to claim 16, wherein said frame and said light guide plate are formed as a whole by a double injection molding.

18. The backlight module structure according to claim 16, wherein said frame has a hollow formed therein.

19. The backlight module structure according to claim 16, wherein said frame is an entire piece of structure.

20. The backlight module structure according to claim 16, further comprising a bezel located under said reflector, wherein said bezel has a plurality of grooves formed in a side wall of said bezel, and said reflector and said frame are fixed to said bezel by combining said plurality of grooves with said plurality of protrusions correspondingly.
